(19) United States
(12) Patent Application Publication
(10) Pub. No.: US 2006/0010074 A1
(43) Pub. Date: Jan. 12, 2006

(54) Delivery and storage system for secured content library

(76) Inventors: Adam M. Zeitsiff, Fort Salonga, NY (US); Matthew B. Rosenberg, Kings Park, NY (US); Joshua Teitelman, Austin, TX (US); Marc Weinstein, Center Moriches, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/888,376

(22) Filed: Jul. 9, 2004

(51) Int. Cl. H04L 9/00

(52) U.S. Cl. 705/52

(57) ABSTRACT

A system for maintaining a secure content library includes a server, which manages requests for copyrighted content and encrypts the content using a key server, which generates unique keys and associates the keys with the copyrighted content to create a token. A gateway receives the token and interacts with the server over a network. A client storage box interacts with the gateway to decode the token in accordance with a security protocol and sends a content key back to the server to enable the content to be downloaded and decoded, the storage box including memory for storing downloaded content. The client storage box has a use key that is updated by the server after a predetermined number of accesses to the content to enable further accessing of the content.

### BACKGROUND OF THE INVENTION

1. Field of the Invention

The present invention relates to secured data transfer and storage, and more particularly to a system and method for flexibly transferring and storing copyrighted content in secured accounts to provide subscribers with an entire library of content accessible from any location that has access to the internet and a client storage box.

2. Description of the Related Art

Many systems are currently available for a viewer to choose and view a movie or television program. These include watching prescheduled programs on television or watching movies at predetermined show times. With the advancement in Internet delivery and cable on-demand services, ordering and watching videos is now possible without leaving home. However, Internet delivery is wrought with problems, some of which include pirated content, unreliable connections, etc. On demand viewing provides convenience but the price of the content has a limited viewing lifetime. Once viewed and the time has expired the movie must be rerented in order to view it again. In addition, the user is limited to the movie selections listed by the service provider. In many instances it would be cheaper to purchase the movie or content, if available in the form of a DVD or VHS tape.

Purchasing movies in the form of DVDs is on the rise and has increased nearly exponentially in the past few years. Owning a DVD of a movie or program ensures a user that they can watch the content at anytime. However, DVDs can be cumbersome in large quantities and can require a significant amount of storage space. In addition, if traveling, it may not be convenient to carry along a viewer DVD collection or significant part thereof.

Therefore, a need exists for a system and method for storing a content library and making the entire content library available at any location without requiring physical storage space other than the set top box device. Another need exists for storing the content library in a secure manner.

### SUMMARY OF THE INVENTION

A system for maintaining a secure content library includes a server, which manages requests for copyrighted content and encrypts the content using a key server, which generates unique keys for each content or movie download and associates the keys with the copyrighted content to create a token. A gateway receives the token and interacts with the server over a network. A client storage box interacts with the gateway to decode the token in accordance with a security protocol and sends the token back to the server to enable the content to be downloaded and decoded. The client storage box has use key that is updated by the server after a predetermined number of accesses to the content to enable further accessing of the content.

The system may include movies as content and the content includes a complete listing of movies purchased and owned by a customer wherein the content is stored on the box, in a master list at the server or both.

These and other objects, features and advantages of the present invention will become apparent from the following detailed description of illustrative embodiments thereof, which is to be read in connection with the accompanying drawings.

### BRIEF DESCRIPTION OF DRAWINGS

The invention will be described in detail in the following description of preferred embodiments with reference to the following figures wherein:

FIG. 1 is a block diagram showing a system for transferring and storing secured content in accordance with one embodiment of the present invention;

FIG. 2 is a block/flow diagram showing security key/token exchange between a service provider and a user in accordance with an embodiment of the present invention;

FIG. 3 is a block diagram showing security levels between a service provider and a user in accordance with another embodiment of the present invention;

FIG. 4 is a more detailed block/flow diagram of the system of FIG. 1 in accordance with another embodiment of the present invention;

FIG. 5 is a flow diagram showing an exemplary method for requesting content, receiving content and storing content in accordance with an embodiment of the present invention; and

FIG. 6 is a block diagram showing a portable storage box in accordance with another embodiment of the present invention.

### DETAILED DESCRIPTION OF PREFERRED EMBODIMENTS

The present invention provides a new and useful system and method for storing and making available an entire content library to a user. A user purchases a piece of hardware, e.g., similar to a set top box, and registers with a service. The user can then download content, such as, a movie or movies to the box or simply download the rights to the content to the box. Once downloaded, a cert gets put into the users vault and the user can access the movie at anytime, from anywhere through an Internet connection via the website or the set top box. When the user decides to view the movie, the movie can be viewed directly from the box on a television or computer monitor. If the user decided to go to a remote location the same movie can be viewed from the box at the remote location on a television at the new location or be downloaded from the Internet or other network at the remote location upon proper verification and demonstration that the rights to the content have been purchased previously.

The present invention will be illustratively described in terms of a video delivery system and method; however, the present invention is applicable to any and all digital information and content, such as music, music videos, television programs, visual static images or digital photographs, audio content, etc.

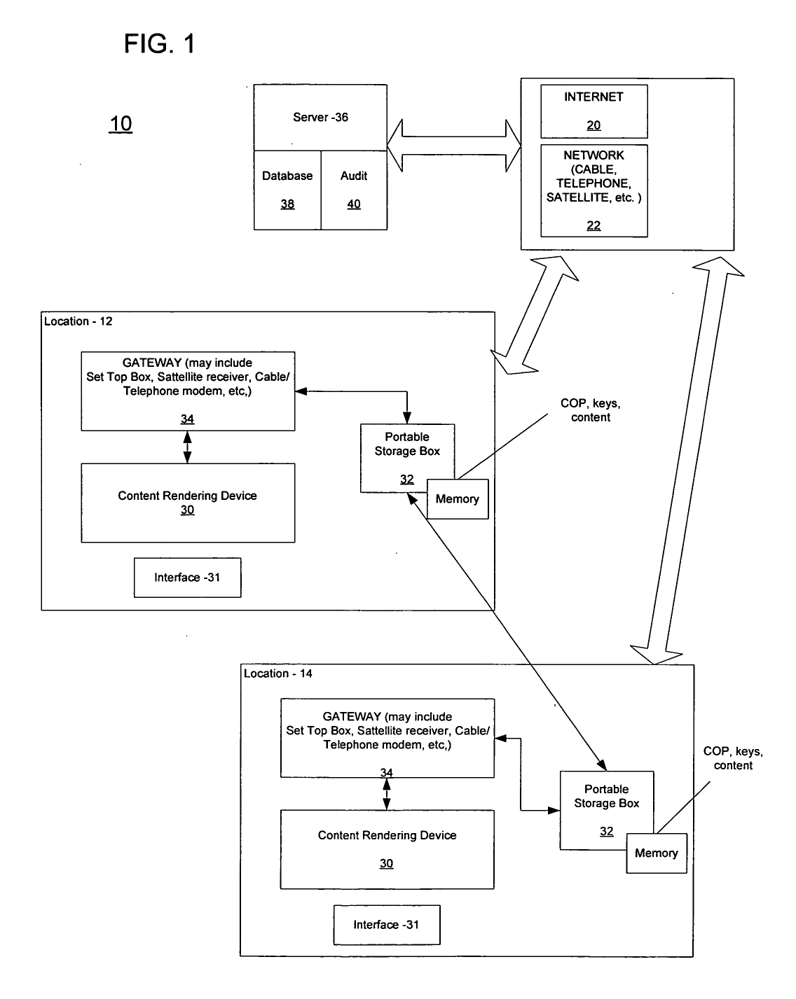

It should be understood that the elements shown in FIGS. may be implemented in various forms of hardware, software or combinations thereof. Preferably, these elements are implemented in a combination of hardware and software based on one or more appropriately programmed general purpose digital set top boxes having a processor and memory and input/output interfaces. Referring now to the drawings in which like numerals represent the same or similar elements and initially to FIG. 1, an illustrative system 10 is shown in accordance with one embodiment of the present invention.

A location 12 may include a user's home or business. At location 12, a content rendering device 30 may include a television, computer, stereo system, display device, etc. depending on the application and the content to be rendered. Rendering device 30 receives content through a gateway 34. Gateway 34 may include a satellite decoder, cable or telephone modem or a cable set top box. Gateway 34 receives transmission from the Internet 20 or from another network 22. Network 22 may include a wired or wireless telephone network, a cable network, a satellite network, a local or wide area network or a direct line connection to a transmission source.

In conjunction with gateway 34, a portable storage box 32 provides memory storage and security protocols for communicating with a server 36 across the Internet 20 or over network 22. Box 32 includes a secured memory storage device (which may be referred to as a vault). In one embodiment, box 32 is capable of storing several hundred movies and their accompanying content. In another embodiment, box 32 stores only a license or use key for each movie as will be explained in greater detail below.

Advantageously, box 32 replaces a users' physical library of DVD's or videos that would normally be physically stored at their location. Box 32 may be integrated with/into gateway device 34, but is preferably portable to permit the user to travel with the library stored onto the box. When traveling to a remote location such as location 14, portable storage box 32 can be directly connected to a gateway 34 at the remote location 14. In this way, stored movies can be viewed directly at the remote location 14. In addition, if access to a server 36 is available new movies or content can be order at the new location 14, since box 32 carries all of the security protocols needed to access and order new content.

In a preferred embodiment, box 32 downloads the desired content, a subset of or the entire library as selected by a user, each time the content is desired. This can be implemented by providing a relevant license key for a particular title or content. When, through a user interface 31, a user requests the title, the box is searched to determine if the rights for that title have been purchased. If the rights were purchased by the individual associated with the box 32, the movie is downloaded to box 32 and can be viewed at any time.

A user registers for box 32 by purchasing box 32. At the time of registration of box 32, the user may set up a profile at a service provider (e.g., server 36). The profile may include personal information for billing and personal viewing preferences, such as movie type, genre, actors, directors, etc. This initial account set up may be considered a main account holder. At the time of registration, the user may also have the option of setting up different sub-accounts under their main account. These accounts could be used for other family members to access all movies or certain movies (for example, any PG-13 movies to their teenagers). Memory of box 32 may be partitioned with a plurality of security levels to keep the main account and sub-accounts separate and inaccessible to others within a same box 32.

After the initial registration, the user may purchase content and manage that content through box 32. A certificate or cert gets issued that the movie was purchased. The reference is then stored in the vault to display library to consumer. Box 32 may reside on gateway 34 or be a separate unit, which interacts with gateway 34. Box 32 refers back to a master list or copy of content located at the service provider, such as on a server database 38 (master list).

According to one aspect of the present invention, box 32 and server 36 communicate intermittently at random intervals or at set times. During this communication, server 36 verifies that all titles and content in box 32 is properly licensed and/or is in operational condition. For example, server 36 determines that its list of movies for a particular user matches the data and content list stored on box 32. In addition, in one embodiment, a request or a check of the content stored on box 32 is checked to determine if a portion is corrupted or damaged, and then repairs the damage.

Box 32 permits a user's entire library to be portable, so wherever the customer travels, if gateway 34 is available and access to the service provider is available, all the user's movies can be viewed at anytime without having to physically transport the movies. Box 32 will have a sufficient amount of memory to store several hundred hours worth of content. The user will have the unique ability to transfer movies back and forth that are stored in a virtual vault (their complete ownership list of content) and on the storage box.

Box 32 gives the user the ability to download the content directly to gateway 34 (e.g, a set top box) for immediate viewing, or to place it into their library (vault) for future viewing. The ability to transfer movies between the gateway 34 and box 32 (vault) at anytime is provided by the present system.

Set top boxes have a limited, though large, capacity to store movies. At the time of download, box 32 will verify the available disk space on gateway 34 prior to download.

By maintaining access to box 32, service providers ensure that copyrighted material is legally used. In addition, by tracking the user's library preference data, advertising or information may be pushed out directly to users, especially to users most interested or affected by the information. For example, new release information for a sequel to a movie already purchased by the user may be sent directly to the appropriate users.

Other promotions may be employed, for example, if a user orders a certain number of movies, the user may attain points from a rewards program good for the purchase or preview of a new movie or the like. In another embodiment, vouchers or gift certificates may be issued with a security code or codes. An option menu can be provided where the code can be entered to redeem a movie or other content.

Server 36 includes an audit module 40. Audit module 40 provides the capability to check the whole content of a user's box 32. Audit security provides delivery of a digital certification (called cert for short) directly to the consumer's gateway 34 and box 32, where the cert is stored in a secure library. Thus, when the user employs their remote control or other interface 31 to scroll through the list of all the movies or content that they own (e.g., movies in stored on box 32), they then see information like, e.g., the name of the movie, the date the movie was purchased, a JPEG or other digital format of the jacket cover of the movie, and the corresponding cert number or key for the purchase. All of this information was stored on and delivered to their box 32 through gateway 34.

In addition, this cert is also stored (redundantly) in a master database 38 at server 36. Having the cert number delivered to box 32, as well as stored in master database 38, permits server 36 to perform a content audit for added security and copyright protection.

The following is an illustrative example of one exemplary audit method. A user purchases a movie via a web site hosted by server 36 or other service provider, or the user directly purchases the movies from a user interface 31 on their gateway 34 (e.g., remote control and display or other known interface). The latter can be performed by pushing movies out to clients who have ordered the movie in advance or the movie may be sent to all gateway devices as part of a promotion, etc.

At the time of purchase, after credit card authorization has taken place or other payment method has been settled, a notification is sent, e.g., via electronic means (e.g., an email or other message) of a certification of purchase (COP) or cert to the consumer. The notification can be to a user designated method and address or location. This notification preferably includes a unique cert number that is generated based upon an encrypted customer ID stored for each account, an order number and a digital picture (jpeg) of the jacket of the movie box. Other information may also be sent and stored in box 32.

The cert number and order number are then placed in both the master database 38 and also delivered to the local library on box 32 (or multiple boxes) that the user owns. The content audit security mechanism in module 40 checks the valid certs in all instances in the database 38 and box 32. If the content the user has on their gateway 34 and in their local library in box 32 does not match that of which is located in master database 38, then copyright issues may arise and server 36 can shut-down operations on the account and notify the account holder. Alternately, other measures may be taken; for example, if a title exists in box 32 that was not paid for the service provider may proactively contact the master account holder. In other embodiments, rights to other titles may be revoked, or any other remedy may be undertaken.

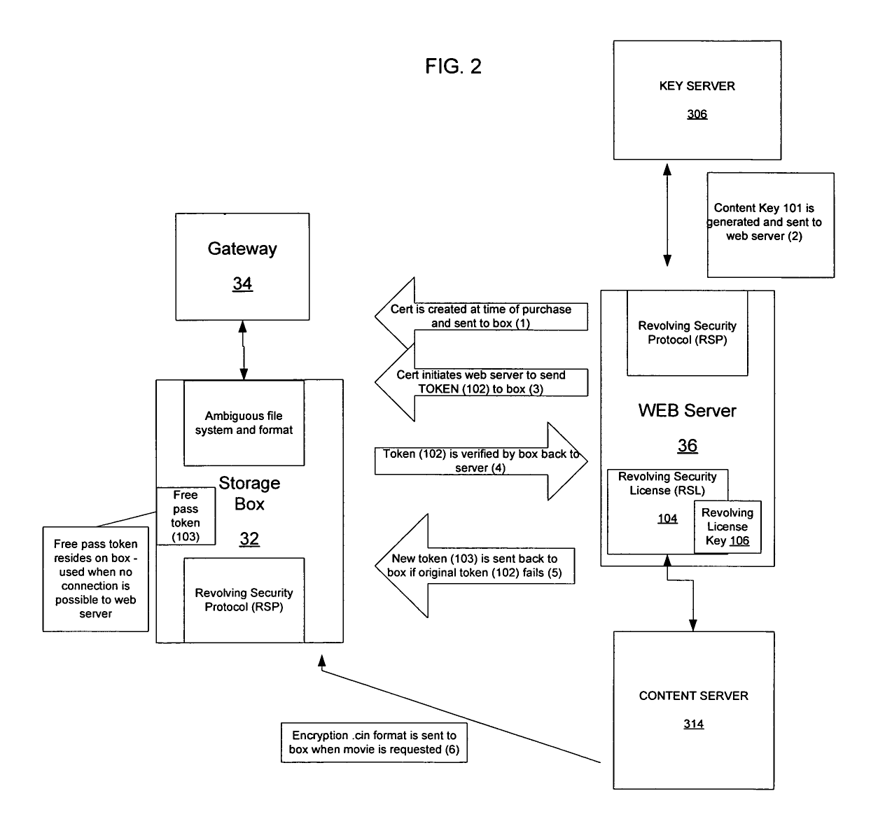

Referring to FIG. 2 with continued reference to FIG. 1, digital rights management (DRM) is provided by system 10 to provide users with legal copies of content. Digital rights management (DRM) for the present invention includes enabling content to be securely purchased, managed, and delivered to customers/users in digital format. In FIG. 2, parenthetical numbers 1-6 show the basic step procedure used in accordance with one embodiment of the present invention. Once the cert is created and sent to storage box 32 and the master vault (indicated by step (1)), then a key server 306 generates a unique content key for that particular movie (indicated by step (2). The content key is then sent to web server 36.

At this time, web server 36 then creates a token 102, which is sent to the storage box 32 (indicated by step (3)). The storage box 32 then verifies that token 102 is for the correct movie purchase with the cert (indicated by step (4)). If the token is incorrect, then a new token 103 will be generated by web server 36 and sent to storage box 32 (indicated by step (5)). At the time the movie is then requested for delivery, a content server 314 sends the encryption format .cin to the box as part of the encoding (indicated by step (6)). The token on storage box 32 is used to communicate with the content key as a part of the DRM process.

Gateway 34 may be a standard set top box, which is retrofitted with an interface to receive and interact with box 32. Gateway 34 may include preprogrammed decoding algorithms or may include memory storage to receive updated decoding keys or algorithms.

The DRM package preferably includes three areas: encryption technology, content audit and security and privileges. Each of these areas act as key stepping-stones to providing a secure environment for content provided by service provider.

The encryption technology provides full-scale security by using a combination of software, hardware and online account information to verify and encode/decode content to ensure security and protect intellectual property. The present invention includes its own “.cin” encryption format for media stored and transferred by system. Passed to the storage box 32 through the content server 314, this format includes the encoded content encrypted at the content server 314. The “.cin” format is comprised of the encrypted content from the DRM encoding that is uniquely created by the service provider as a new format of file types and only playable through server 36 and storage box 32 drivers and tokens.

Once the content is downloaded to box 32, it is stored in an ambiguous format on a file system of box 32. The ambiguous format will include a cin extension preceded by a uniquely created key that is defined by a large alpha-numeric string of data that identifies the content. A content key deployed with the specific digital content is re-encrypted and subsequently protected on a per-request basis (e.g., each time a movie is played). This process includes a revolving security protocol (RSP), which renews the security checks for each individual movie purchase.

RSP in accordance with the present invention includes encrypting each file (content) differently, using different combinations of information to encode the content more securely. For example, a portion of the cert and the account number, and a portion of the content are mixed and encoded to provide a unique content key 101. Content key 101 and its method of formation are stored at server 36. Other combinations of information may include a portion of a user-defined password, the cert and a portion of the content. Other combinations are also contemplated.

Box 32 and server 36 exchange security information to determine the authenticity of box 32. Information exchanged includes box 32's hardware profile. Kernel and other related modules of box 32 and username/password information for the account. If any piece of the security information is not authenticated, then box 32 will be denied access to server 36.

Random number generators may be employed to select portions of content (by addresses or other predetermined criteria), portion of security keys, certs, account numbers, passwords, date or order, movie or content title or any other digital information.

RSP can run certain comparison checks on the content, which are preferably done upon boot up of gateway 34 and/or at the time of content play. Verification of software signatures and verification of hardware components may also be processed to check integrity of gateway 34 and box 32. This provides a proactive step in assuring that software or hardware modifications have not been made to capture or decode the content server 36 is securing.

A token 102 may be implemented that is composed of both a hardware profile key of the user's gateway 34 or box 32; as well as a rotating license key 106 that is retrieved from a trusted Revolving Security License (RSL) Servers 104 at periodic intervals. In other words, access to the content key 101 is controlled via a rotating license key 106, which must be validated against a trusted license server 104. License key is employed in the generation of token 102 using content key 101.

Also, the content key 101 and token 102 are no longer valid after the content has been played, so after each or a predetermined number of viewings, a new token 103 is automatically retrieved from the RSL server 104. This ensures that the ability to discover and hack the token 102 has a limited life span. This scenario needs a periodically active connection to server 36 from the client side; however, if the key validation occurs only periodically, then the key or keys are stored on the client during the valid period. This enables the content to be viewed without a constant connection giving the consumer one or more free passes to view the content without a live connection. For example, a user subscribes to the present service and receives a token 102. After viewing the movie, the key is updated by server 104 to enable the movie to be viewed again. However, if the user decides to go to a remote site to view the movie again, at the remote site, no access to server 104 is available. Box 32 includes one or more free passes with a new content key and token 103 to permit another viewing of the movie. Once the content has been viewed the key is no longer valid, and a new key is encrypted within the file the next time the consumer plays the movie. Then, once access to server 104 can be reestablished, server 104 will recognize the content key 103 as a free pass key and accept this key based on information stored in box 32.

A media path from drivers of server 36 to a media player at the user's location needs to be secured. This is needed to ensure the media stream cannot be captured after it has been decoded and before it arrives to the video output of gateway 34, e.g., a set top appliance. This may be performed by the encoding methods and system selected as described above.

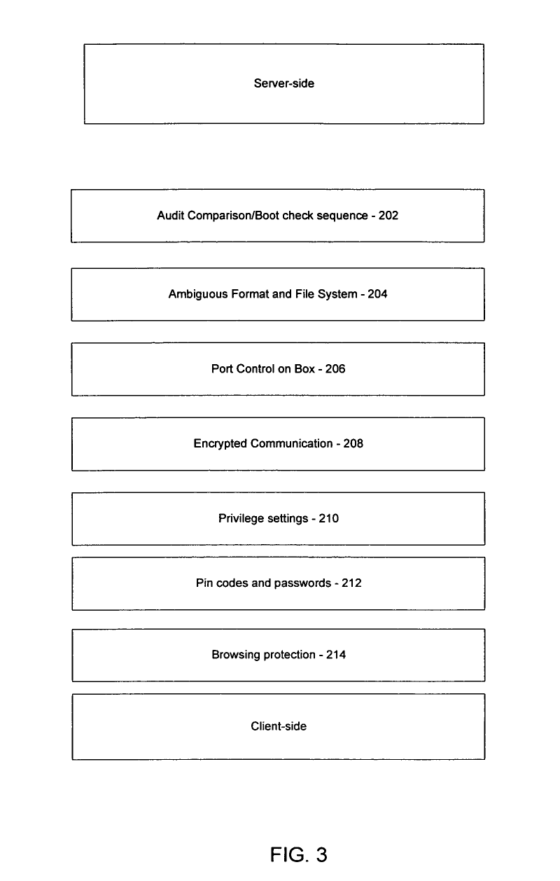

Referring to FIG. 3, several security layers are provided to ensure system integrity and that the content transferred or stored is not pirated or stolen. A general box lockdown may occur if a violation of the content comparison between database 38 and box 32 fails. In one scenario, a boot check sequence 202 is run and if no match to media access control (MAC) addresses and other hardware signatures is made, then the user devices are prevented from boot up. Movies are preferably stored in an ambiguous format and file system 204 so that accessing these files is extremely difficult by non-users. Ports opened 206 only when box 32 is communicating with server 36. Otherwise, there is a 100% lock-down such that all other services on box 32 are inoperable, including all I/O ports. Encrypted communication 208 is provided between box 32/gateway 34 and server 36.

Privileges 210 are granted based upon agreement terms between client and service provider. Other privileges between an account holder and subaccount holders can be established. For example, a master account user and sub-account users may include different specific security options. For example, viewing times, content rating specific, and content specific privileges may all be limited in accordance with privilege settings or agreements. These privileges may extend to purchasing content as well as viewing content. For example, rating specific and content specific privileges may be limited for sub-account users, e.g., children and granted to main or master account holders. In another embodiment, all purchases must be requested through the master account.

Optional pin codes 212 may be provided for individuals for protecting accounts and content from outsiders and other account and sub-account holders.

Browsing protection 214 may include limited access depending on the activities of a user. For example, a user that is not logged in will be able to view all content on box 32 or in gateway 34 if proper access is granted. If logged in a user will only view content on server 36 or on defined by privileges.

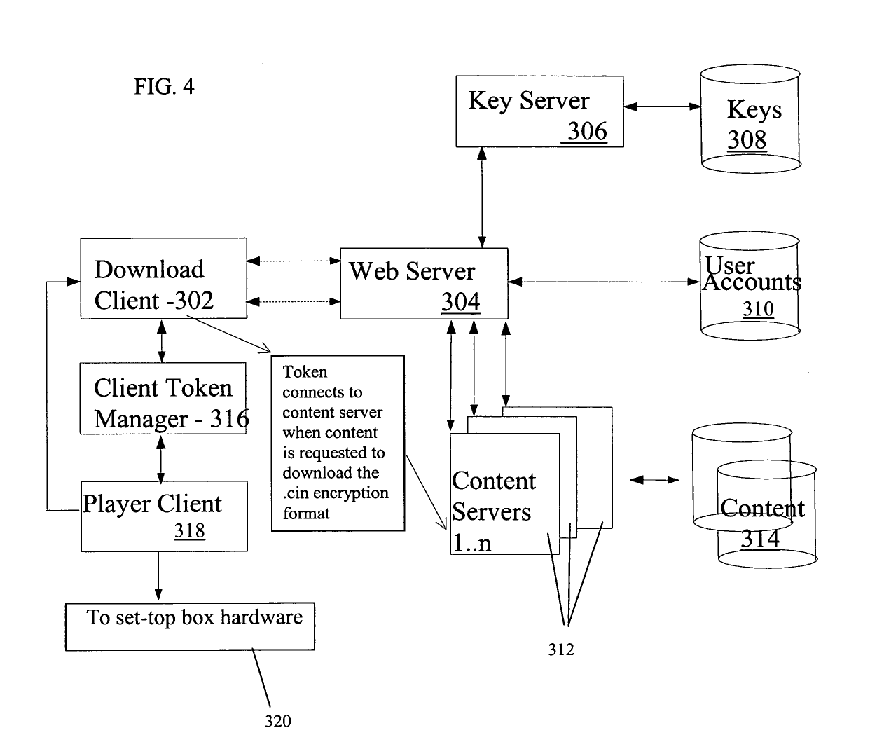

Referring to FIG. 4, a block/flow diagram illustratively shows server security and digital rights management (DRM) in accordance with an exemplary system/method 301 of the present invention. FIG. 4 will illustrate the flow of data and logic between a client download application, the client play application, a key server, a web server, and content servers for the DRM and security portion of the present invention.

The DRM provided makes copying content more difficult and inconvenient than copying a DVD. As a result, this assists in keeping content transfer legal while providing hackers an incentive to look elsewhere for content that can be compromised. In addition, it ensures that the client player box 32 cannot be used for play of unauthorized or illegally copied content. Furthermore, the security described herein includes client-server authentication to prevent unauthorized users from “spoofing” valid accounts, to prevent non-clients from accessing the system (thus preventing man-in-the-middle attacks).

Noting the need to provide a certain number of content plays without an active connection to a server requires that the key decrypt the content stored temporarily on the client hardware outside of memory. This may be a security issue. The key will still be encrypted and obfuscated, but a 100% secure solution if the key and content must co-exist is very difficult.

Two major client functions in the system 301 include downloading content and playing content. These functions involve both server and client software components. The major software components involved in these functions may include the following.

On the server side, a web server or other server 304 is employed. This is the same server 36 as referenced above. Server 304 is where the client application connects to create new accounts, browse for content and request content. Server 304 is responsible for managing client accounts 310 and meta-information about content and where the content is located. Server 304 is responsible for authenticating clients.

Server 304 includes a key server 306, which may be remotely located relative to server 304 or included in server 304. Server 306 is similar to server 104. Key server 306 is responsible for generating and managing content keys 308 that have lifetimes.

Content servers 312 are responsible for hosting the actual content files, and transmitting content to authenticated clients who have requested the content with an authenticated request token. These servers 312 are preferably scalable and robust, and distribute both content and client load appropriately. Content servers 312 may be remotely located relative to server 304 or may be integrated therein. Keys 308, user accounts 310 and content 314 comprise database 38 as described with reference to FIG. 1.

On the client side, a gateway 34 includes a download client 302. The download client 302 is responsible for interacting with the web server 304 to perform client-server authentication. Once authentication is complete, client 302 is also responsible for interacting with the content servers 312 to download content. Download client 302 interacts with a client token manager 316 to store tokens when received by the server 304. Token manager 316 is responsible for managing the tokens that control access to content. This includes determining whether a given token is valid at a given time current time. A token is employed to connect client 302 to content server when content is requested to download the cin encryption format.

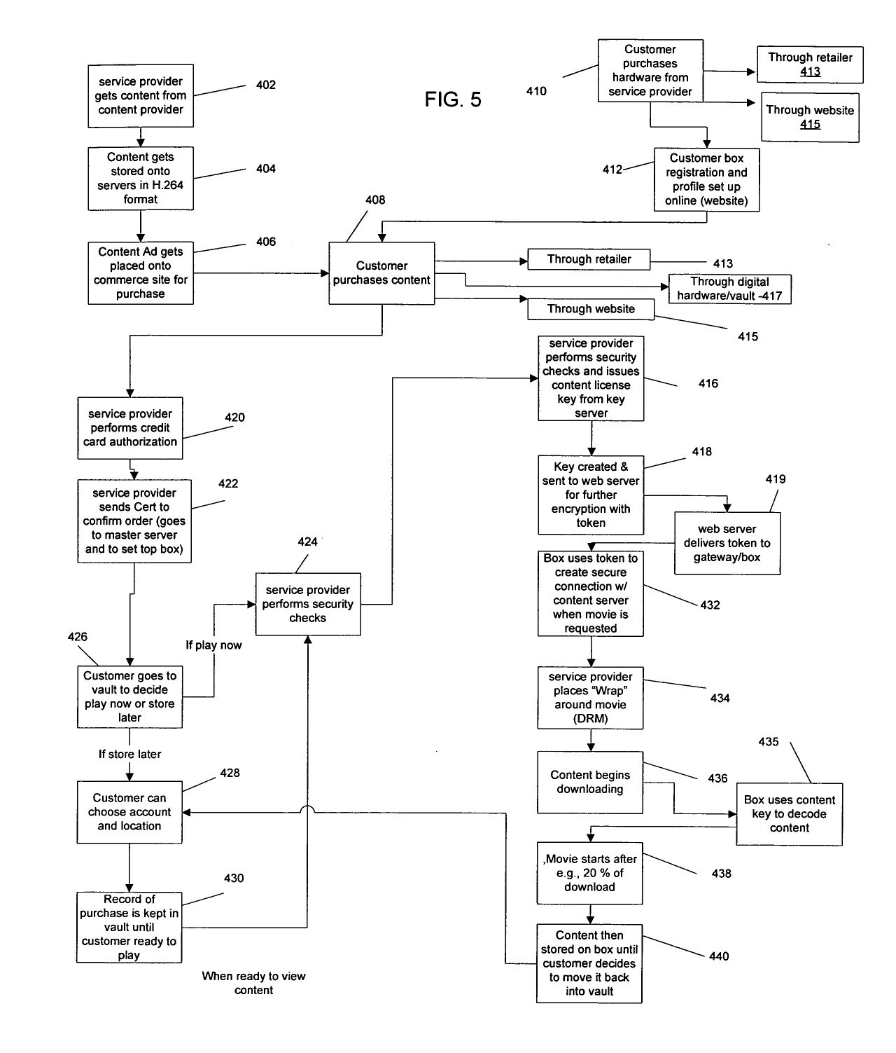

A content player 318 is responsible for interacting with the token manager to determine if desired content is currently playable. If playable, then the content player decrypts and streams the content to hardware 320 (See e.g., blocks 432-438 of FIG. 5). If it is not playable, then the player directs the download client 302 to request a new play token from the web server 304.

The downloading and playing functions are both needed and optional features that may be provided as well for DRM and security.

For downloading content, download client 302 opens an SSL (Secure Socket Layers) session with web server 304 to request new content. Web server 304 verifies that the client is known and valid by checking one or more of: the client's hardware profile, the client's signed kernel and related modules, and client's user account name and password. All of these should be sent to server 304 with private key encryption and verified by client's public key on server 304.

If the client is not valid, the web server 304 asks if the client would like to sign up as a new user. New user registration is preferably handled through the web interface. This will direct the user to go online and finish the registration process. Integration of the registration process with the web server 304 will need to be given to provide the same support for authentication.

After web server 304 has validated user, server 304 prepares content for delivery. Server 304 locates content server(s) 312 from which content will be downloaded. This could be based on various algorithms for content partitioning and load sharing on the server side. Server 304 then requests a content key 308 from key server 306.

Key server 306 creates Advanced Encryption Standard (AES) content and transmits the same to web server 304. Content key 308 is based on the client's hardware profile, content or other client information. A rotating key is generated on Rotating License Server (RSL) (a rotating key is one that expires after a given time period), which is preferably incorporated in key server 306 (or even in web server 304). RSL transmits the encrypted content key to web server 304.

Web server 304 creates and transmits content “token”. The content “token” combines the encrypted content key with an authorization header that preferably includes a unique identifier, the key's expiration date/time, a number of valid plays of this content, an address of the content server 312 from which this content is to be downloaded, client hardware profiles, and/or signatures of the client kernel/module. This may be provided in conjunction with the revolving license key

Server 304 encrypts the token preferably using the client's hardware profile, the key that is embedded and obfuscated within the client application instance or content. The information used for creating the token may include the client's hardware ID numbers, the client's password, the clients account number(s), parts of the content to be downloaded, etc. Server 304 transmits the token to the client.

Download client 302 decrypts the token and requests content download from the content server 312 listed in the token. Download client 302 opens a socket connection to content server 312 and requests content by passing the unique token identifier. SSL may be used, for example, for content transport and client-server authentication. Using SSL for content transport means the content is encrypted twice (e.g., via AES and SSL).

Content server 312 transmits content in an obfuscated manner. Content server 312 may first transmits “chaff” (e.g., garbage bits that obfuscate the start of the content bits). Content server 312 then AES encrypts content as it is spooled to client 302. SSL may be used for content transport and client-server authentication. Using SSL for content transport means the content is encrypted twice (e.g., via AES and SSL).

Download client 302 manages the encrypted token locally, such that the token is associated with the content and can be decrypted when a play of that content is requested.

The client plays content by first decrypting the token associated with desired content into memory using token manager 316. The client examines the token to determine if content is currently playable and then authenticates the hardware profile, and optionally authenticates kernel/module signatures. An authorization header is checked to see if content is playable at this date/time given the headers number of authorized plays left. If playable, the token's number of authorized plays is reduced by 1. If not playable, the player client 318 requests a new play token from web server 304 through download client 302.

Client player 318 uses an AES key in the token to decrypt content and stream to hardware player 320. Client player 318 may provide the ability to skip, fast forward and rewind content. Also, the content will be encrypted in such a way as to replicate chapter functionality from a true DVD menu allowing certain start points in the content to be selected. The content or the rights to the content can then be stored for future use or to permit access to the content for future use from a remote location (other than the client's site).

It is to be understood that the functions and capabilities of blocks 302, 316 and 318 may be provided in box 32 (FIG. 1). In addition, box 32 preferably includes a large memory for storing content. Alternately, the memory will store licensing information and rights in conjunction with the full content (in the vault).

Referring to FIG. 5, a general process flow for a system/method of storing and transferring secured media content is illustratively shown for the exemplary case of downloading and storing a movie. In block 402, a service provider gets licensed content from a content provider. The content provider may include a movie studio, artist or other content provider. The content is stored, preferably in H.264 format onto content servers (e.g., 312 in FIG. 4) in block 404. In block 406, an ad or other notification is placed onto a commerce site (e.g., server 36 in FIG. 1) or otherwise presented to users or potential users.

In block 410, a customer purchases a storage box (32) or a home theatre, which may include a gateway device, such as a set top box adapted to be used in accordance with the present invention. These may be purchased through various means, as indicated by blocks 413 and 415. Box 32 or theatre may be purchased through a retailer 413 or a website 415, for example.

In block 412, the customer box is registered and the customer sets up a profile and registers as a user, including credit card details. In block 408, the customer or user purchases the content that they want to own. This purchase can be made through a retailer 413 or through a website 415 or directly through the set top box itself (e.g., vault 417). Purchasing the content is performed in accordance with privileges and preferences, as described above. Purchasing involves purchasing a license to view or use the material. In this respect, the content itself need not be downloaded at this time since the rights are what have been purchased. This permits the content to be downloaded at anytime or at any location (to a registered box) capable of access to the service provider.

After a request for content is made, a payment method is researched, and in one example, a credit card is used and the purchase is made after authorization is provided in block 420. In block 422, a cert is sent to the user and to the users vault to confirm the order. This cert is stored in the storage box of the user or customer in addition to the master vault list. In block 426, the customer decides whether to play now or store the content for later. If the user decides to play the movie now, then in block 424 security checks are performed by the service provider. In block 416, the security checks include issuing a content license key to the user.

In block 418, the content key is generated and sent to the web server for further encryption with the token. In block 419, the web server delivers the token to the gateway/box. The box uses a token derived from the web server to create a secure connection with the content server in block 432. In block 434, the service provider places a “wrap” around the movie using the DRM methods described above. This wrap includes providing a new key for the movie from the service provider to enable a next viewing. Alternately, if access to the service provider is not available a free pass may be used to substitute for the wrap, if available. The box employs a token to decode the content in block 435.

In block 436, the content begins downloading if the security checks pass, and simultaneously, in box 435 the storage box uses the token to decode the content, and the movie will start after downloading after the appropriate download time (this is called progressive play). The content can be stored on gateway or directly in the storage box in block 440.

If in block 426, the customer decides to store the movie for later viewing, the customer can choose the account and location where they desire the movie to be stored. The movie is preferably stored on a gateway or in a storage box of the user. However, the user may have several registered locations and/or may want to purchase the movie for another person. In block 430, a record of the purchase is kept in the storage box (vault) and at the service provider (vault). In this way, the movie can be played at any time.

The movie rights for personal viewing are owned by the user as designated by the proof of purchase or certification of purchase (COP) or cert. The content may be stored on the storage box or on a remote database of the service provider. If proof of ownership is presented to the server database, the movie content can be released by the server for viewing by the registered user at any location. When the user is ready to view the stored content, the method begins again at block 424.

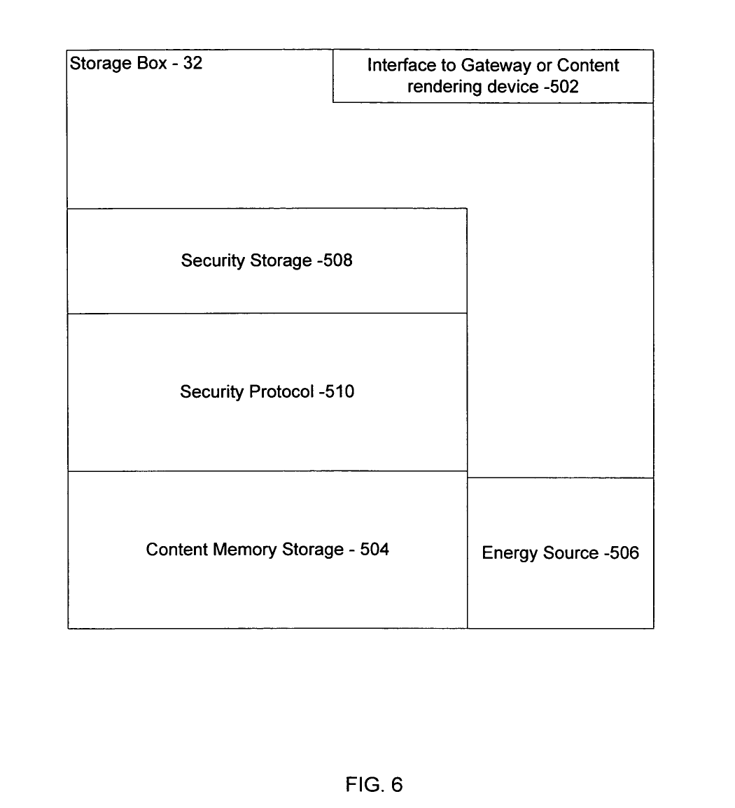

Referring to FIG. 6, a storage box 32 is shown in greater detail in accordance with one embodiment of the present invention. Box 32 includes content memory storage 504, which may include read only memory since the content stored therein is designated as a portion of a content library. As read only memory, the memory is easily portable and cheaper than volatile memory systems. However, volatile memory systems are contemplated. An energy source 506 or other energy storage device is preferably provided. Energy source 506 may be employed to refresh volatile memory systems, for example, or permit functionality of box 32 when box 32 is not attached to another memory source. Source 506 may include a battery or an AC connection or other energy source.

Storage box 32 includes an interface to a gateway or content rendering device such as a TV, personal digital assistant, computer, stereo, telephone, etc. In an alternate embodiment, storage box 32 may be integrated directly into a gateway device or a content rendering device.

In one embodiment, content memory 504 does not include any content. Instead, it includes the digital certifications for accessing the content from a service provider and proof of purchase. For example, instead of downloading “Gone with the Wind”, the user owns the rights to view this movie and a certificate or purchase and license rights are stored in the form of an encrypted word or sequence. When the user decides to view the movie, the movie can be downloaded from the service provider to box 32. In this embodiment, memory storage space is extremely reduced, but the flexibility of receiving content at a convenient location is provided.

Box 32 includes security protocol 510 and security storage 508, which work in conjunction with server to provide the security features as described above.

Box 32 permits a user to store an entire library of content without the storage space requirement of a DVD or VHS library. In addition, content providers are ensured that their copyrighted content is safe from pirating and misuse. The box will have a finite amount of storage space that has the potential to be upgraded in the future. The user or customer will be able to store several hundred hours worth of movies and content onto the box. However, the customer can purchase and unlimited amount of movies and content. The content that does not phycsically sit on the box, is stored in the users virtual vault on the server. A master listing of their vault will always be accessible and reside on both the box itself and the master list. Users can then transfer (upload/download) movies from the vault to the box and vice versa.

Having described preferred embodiments of a system and method for delivery and storage system for a secured content library (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

1. A system for maintaining a secure content library, comprising:
a server which manages requests for copyrighted content and encrypts the content using a key server which generates unique keys and associates the keys with the copyrighted content to create a token wherein the server includes a revolving license key server such that a revolving license key is issued and updated to the user as a use key after a predetermined number of accesses to the content;
a gateway which receives the token and interacts with the server over a network; and
a client storage box which interacts with the gateway to decode the token in accordance with a security protocol and sends the token back to the server to enable the content to be downloaded and decoded, the storage box including memory for storing downloaded content;
the client storage box having the use key that is updated by the server after a predetermined number of accesses to the content to enable further accessing of the content.

2. The system as recite in claim 1, wherein the client storage box is detachable and portable without deleting the content.

3. The system as recited in claim 1, further comprising a system audit module which intermittently compares content stored in the storage box against a master content list stored on the server, wherein the server controls operation of the storage box in the event that a discrepancy occurs between the master content list and the content stored on the storage box.

4. The system as recited in claim 1, wherein the storage box includes privilege information, which limits content available for purchasing and accessing.

5. The system as recited in claim 1, wherein the content includes movies and the storage box stores the movie content.

6. The system as recited in claim 1, wherein the content includes a complete listing of movies purchased and owned by a customer wherein the content is stored on the storage box, in a master list at the server or both.

7. The system as recited in claim 1, wherein the storage box stores only digital words permitting rights to view the content.

8. The system as recited in claim 1, wherein the storage box is employed to transfer a library of content for rendering at any remote location.

9. The system as recited in claim 1, wherein the server further comprises a database, which stores one or more of unique keys, account information and content.

10. The system as recited in claim 1, wherein the unique keys are encrypted with the client requested content and are employed to update the use keys.

11. The system as recited in claim 1, wherein the storage box includes a free pass to substitute for a use key when the storage box lacks access to the server.

12. The system as recited in claim 1, wherein one of the tokens, and the use keys are encrypted based on data in one or more of the client's hardware information, the client's account information and a portion of the content.

13. (canceled)

14. The system as recited in claim 1, wherein the revolving license server includes a revolving security protocol (RSP) to generate a revolving key unique to each individual piece of content.

15. The system as recited in claim 1, further comprising a certification for proof of purchase and for library cataloging content, the certification including unique identifiers, a cert number, at least a portion of content and hardware identifiers.

16. A system for maintaining a secure content library, comprising:
a server which manages requests for copyrighted content and encrypts the content using a key server which generates unique keys and associates the keys with the copyrighted content to create tokens;
a plurality of gateways remotely disposed relative to each other and the server which receive the token and interact with the server over a network;
a client storage box which interacts with the gateways to decode the token in accordance with a security protocol and sends a content key back to the server through any of the gateways to enable the content to be downloaded at the location of the storage box, the storage box including memory for storing downloaded content and a free pass to substitute for a use key when the storage box lacks access to the server;
a system audit module which intermittently compares content stored in the storage box against a master content list stored on the server, wherein the server controls operation of the storage box in the event that a discrepancy occurs between the master content list and the content stored on the storage box.

17. The system as recite in claim 16, wherein the client storage box is detachable and portable without deleting the content.

18. The system as recited in claim 16, wherein the storage box includes read only memory for storing the content.

19. The system as recited in claim 16, wherein the storage box includes privilege information, which limits content available for purchasing and accessing.

20. The system as recited in claim 16, wherein the content includes movies and the storage box stores the movie content.

21. The system as recited in claim 16, wherein the storage box stores only digital words permitting rights to view the content from the server.

22. The system as recited in claim 16, wherein the storage box is employed to transfer a library of content for rendering at any remote location.

23. The system as recited in claim 16, wherein the server further comprises a database, which stores one or more of keys, account information and content.

24. (canceled)

25. The system as recited in claim 16, wherein the content includes a complete listing of movies purchased and owned by a customer wherein the content is stored on the storage box, in a master list at the server or both.

26. (canceled)

27. (canceled)

28. (canceled)

29. A system for maintaining a secure content library, comprising:
a server which manages requests for copyrighted content and encrypts the content using a key server which generates unique keys and associates the keys with the copyrighted content to create a token a gateway which receives the token and interacts with the server over a network; and
a client storage box which interacts with the gateway to decode the token in accordance with a security protocol and sends the token back to the server to enable the content to be downloaded and decoded, the storage box including memory for storing downloaded content;
the client storage box having a use key that is updated by the server after a predetermined number of accesses to the content to enable further accessing of the content, the storage box including a free pass to substitute for a use key when the storage box lacks access to the server.
